(19) United States
(12) Patent Application Publication
(10) Pub. No.: US 2025/0164618 A1
(43) Pub. Date: May 22, 2025

(54) ANGLE COMPENSATION METHOD, ELECTRONIC DEVICE AND AUTONOMOUS MOBILE ROBOT EMPLOYING METHOD

(71) Applicants: Futaijing Precision Electronics (Yantai) Co., Ltd., Yantai (CN); HON HAI PRECISION INDUSTRY CO., LTD., New Taipei (TW)

(72) Inventor: Hsiao-Lun Chen, New Taipei (TW)

(21) Appl. No.: 18/425,344

(22) Filed: Jan. 29, 2024

(30) Foreign Application Priority Data
Nov. 17, 2023 (CN) 202311536049.4

(51) Int. Cl. G01S 7/497; G01S 17/931

(52) U.S. Cl. CPC G01S 7/497; G01S 17/931

(57) ABSTRACT

A angle compensation method for improving an accuracy of a light detection and ranging (LiDAR) for position detection includes: obtaining a first position of an object, the first position being an actual position of the object relative to a predetermined reference area; obtaining a second position of the object detected by the LiDAR when the LiDAR reaches the predetermined reference area; obtaining a first distance between the second position and the first position; and determining a compensation angle of the LiDAR according to the first distance, the compensation angle being configured to compensate an angle detected by the LiDAR. An autonomous mobile robot and an electronic device are also disclosed.

### TECHNICAL FIELD

The subject matter herein generally relates to angle compensations of light detection and ranging (LiDAR).

### BACKGROUND

LiDAR can be applied to autonomous mobile robots (AMRs), the LiDAR can be used to detect surrounding environment information of the AMR for navigation, creating an area map, or observing a surrounding environment for warning, etc.

However, an installation error of the LiDAR and a production error of the LiDAR may cause a deviation between an angle of an object detected by the LiDAR and an actual angle of the object, reducing a detection accuracy of the object by using the LiDAR.

### BRIEF DESCRIPTION OF THE DRAWINGS

Implementations of the present disclosure will now be described, by way of embodiments, with reference to the attached figures.

FIG. 1 is a block diagram illustrating an angle compensation system according to an embodiment of the present disclosure.

FIG. 2 is a scenario diagram illustrating a predetermined reference area according to an embodiment of the present disclosure.

FIG. 3 is an installation position diagram illustrating a fixed device according to an embodiment of the present disclosure.

FIG. 4 is a flowchart illustrating an angle compensation method according to an embodiment of the present disclosure.

FIG. 5 is a scenario diagram illustrating an AMR moving to a predetermined reference position according to an embodiment of the present disclosure.

FIG. 6 is a scenario diagram illustrating a first position and a second position of an object according to an embodiment of the present disclosure.

FIG. 7 is a block diagram illustrating an electronic device according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

An light detection and ranging (LiDAR) can be applied to an autonomous mobile robot (AMR), the LiDAR can be used to detect surrounding environment information of the AMR for navigation, map building, locating and tracking. An installation error of the LiDAR and/or a production error of the LiDAR may cause a deviation of a detection result of the LiDAR, reducing a detection accuracy of the LiDAR.

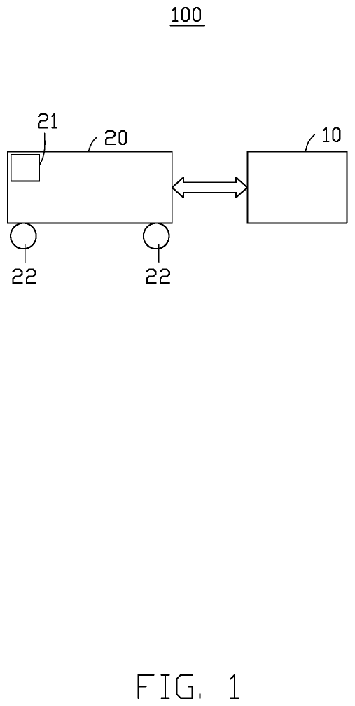

FIG. 1 illustrates one exemplary embodiment of an angle compensation system 100. The angle compensation system 100 may include an electronic device 10 and the AMR 20. The AMR 20 includes the LiDAR 21, the AMR 20 can communicates with the electronic device 10.

In one embodiment, the electronic device 10 can be configured to perform an angle compensation method. The angle compensation method may include: obtaining a first position of an object, the first position being an actual position of the object relative to a predetermined reference area; obtaining a second position of the object detected by the LiDAR 21 of the AMR 20 when the AMR 20 reaches the predetermined reference area; obtaining a first distance between the second position and the first position; and determining a compensation angle of the LiDAR 21 according to the first distance, the compensation angle being configured to compensate an angle detected by the LiDAR 21.

In one embodiment, when the AMR 20 reaches the predetermined reference area, the LiDAR 21 of the AMR 20 may face the object, and the electronic device 10 can obtain the detection position (second position) of the object through the LiDAR 21. The AMR 20 can use the compensation angle to compensate a detecting angle of the LiDAR 21, and the detection accuracy of the LiDAR 21 can be improved.

In one embodiment, the electronic device 10 may be a device or module that can automatically perform calculation and/or information processing according to pre-set or stored instructions, and the electronic device 10 may include, but is not limited to, a processor, a microprogrammed control unit (MCU), an application-specific integrated circuit (ASIC), a programmable gate array (FPGA), a digital signal processor (DSP), an embedded device, etc.

In one embodiment, the AMR 20 is configured for obtaining an initial detection angle of the object detected by the LiDAR 21, and obtaining an actual angle of the object according to a compensation angle and the initial detection angle.

For example, when the compensation angle is N degrees of clockwise deflection of the second position relative to the first position, the AMR 20 can rotate the initial detection angle counterclockwise to N degrees to obtain the actual angle of the object. When the compensation angle is N degrees of counterclockwise deflection of the second position relative to the first position, the AMR 20 can rotate the initial detection angle clockwise to N degrees to obtain the actual angle of the object.

The AMR 20 can obtain the compensation angle of the LiDAR 21. When the object is detected by the LiDAR 21, an detecting angle of the object is compensated by the compensation angle, then the actual angle of the object can be obtained, and the detection accuracy of the AMR 20 can be improved.

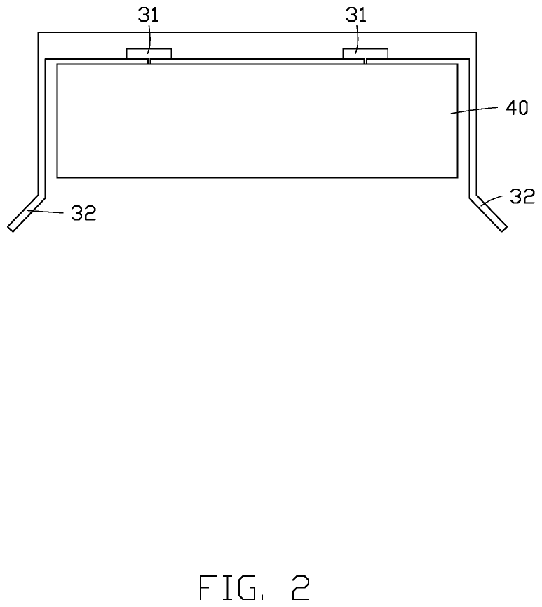

Referring to FIG. 2, the angle compensation system 100 further includes at least one pressure sensor 31. The pressure sensor 31 is arranged at a wheel docking position of the predetermined reference area 40. When the AMR 20 moves to the predetermined reference area 40, a wheel 22 of the AMR 20 can be in contact with the pressure sensor 31.

In one embodiment, the angle compensation system 100 may include two pressure sensors 31. Positions of the two pressure sensors 31 can correspond to two moving wheels 22 of the AMR 20 respectively. A distance between the two pressure sensors 31 can be equal to a distance between the two wheels 22 of the AMR 20.

The pressure sensor 31 is configured to detect a pressure value and transmit the pressure value to the electronic device 10. The electronic device 10 is configured to determine whether the pressure value is within a predetermined pressure range after receiving the pressure value. When the pressure value is within the predetermined pressure range, the LiDAR 21 is determined to reach the predetermined reference area 40.

In one embodiment, when the pressure value is less than a minimum value of the predetermined pressure range, indicating that the pressure value is too small, and the AMR 20 does not reach the predetermined reference area 40. When the pressure value is greater than a maximum value of the predetermined pressure range, indicating that the pressure value is too large, and the AMR 20 is pressed on the pressure sensor 31, not in contact with the pressure sensor 31, and a located area of the AMR 20 may exceed the predetermined reference area 40.

In one embodiment, the predetermined pressure range can be defined according to an actual application. For example, the maximum value of the predetermined pressure range is less than a weight of the AMR 20, and the minimum value of the predetermined pressure range is greater than 0.

In one embodiment, the AMR 20 can be accurately determined to be in the predetermined reference area 40 or not through the pressure sensor 31 and the predetermined pressure range, to accurately obtain the compensation angle.

In one embodiment, the angle compensation system 100 may further include a guide rail 32, the AMR 20 can move on the guide rail 32, and the guide rail 32 can guide the AMR 20 to a predetermined reference position of the predetermined reference area 40, and the LiDAR 21 of the AMR 20 can face the object to be detected.

In one embodiment, the guide rail 32 can limit a moving of the AMR 20, and the AMR 20 can accurately move to the predetermined reference position.

In one embodiment, the AMR 20 may configure a machine frame, and the detection of the AMR 20 being in the predetermined reference area 40 is to detect whether the machine frame is in the predetermined reference area 40.

In one embodiment, shape or size differences of machine frames are small, and shape or size differences of AMRs are large. The embodiments use the machine frame to determine a positioning of the AMR 20, which can reduce a positioning difference caused by the shape or size differences of the AMR 20, and conducive to a batch calculation of compensation angles of AMRs of a production line.

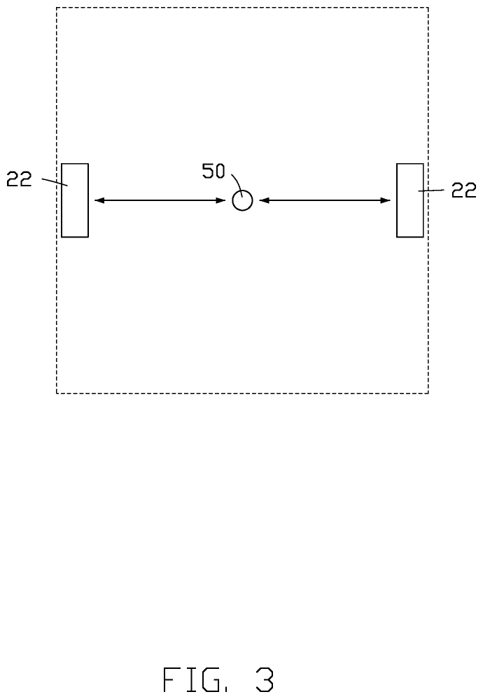

Referring to FIG. 3, the angle compensation system 100 may further include a fixed device 50. The fixed device 50 is located in the predetermined reference area 40. The fixed device 50 is configured to fix the AMR 20 in the predetermined reference area 40.

For example, the fixed device 50 can be arranged in a middle position of the docking position of the two wheels 22 in the predetermined reference area 40. The docking position of the two wheels 22 is a position that the two wheel 22 of the AMR 20 is located when the AMR 20 reach the predetermined r reference area 40.

In one embodiment, the fixed device 50 may include a latch, the machine frame of the AMR 20 may equip a positioning hole that matches with the latch. When the AMR 20 arrives at the predetermined reference position, the electronic device 10 can control the latch to rise and the latch can be inserted into the positioning hole, so that the AMR 20 can be fixed at the predetermined reference position.

In one embodiment, when the AMR 20 arrives at predetermined reference position and the pressure value of the pressure sensor 31 is within the predetermined pressure range, the AMR 20 is fixed at the predetermined reference position by the fixed device 50, so that the AMR 20 can detect the object under a stable state, a detection error caused by an unstable state can be avoided, and a calculation error of the compensation angle caused by a detection error can be avoided, improving the accuracy of the compensation angle.

The angle compensation system 100 can determine the AMR 20 arrives at the predetermined reference area 40, comparing with manual observation whether the AMR 20 arrives at the predetermined reference area 40, an observation error can be reduced, an efficiency of angle compensation can be improved, and a test efficiency of the production line can be improved.

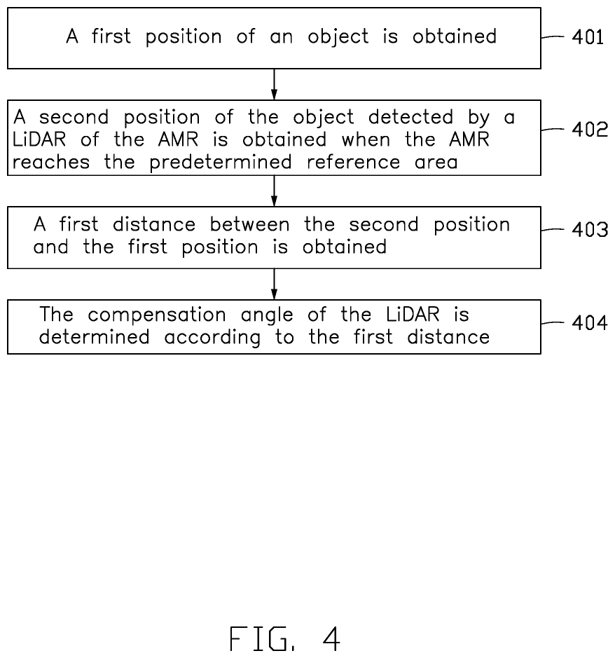

FIG. 4 illustrates one exemplary embodiment of an angle compensation method. The angle compensation method can be applied to an electronic device (for example, the electronic device 10 as shown in FIG. 1). The flowchart presents an exemplary embodiment of the method. The exemplary method is provided by way of example, as there are a variety of ways to carry out the method. Each block shown in

FIG. 4 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can be begin at block 401.

In block 401, a first position of an object is obtained.

In one embodiment, the first position is an actual position of the object relative to a predetermined reference area. The object can be a thing with a symmetrical shaped for easy detecting and positioning.

In one embodiment, a position of the predetermined reference area can be defined according to an actual application requirement. For example, the predetermined reference area can be defined according to a size of a test site.

For example, when the AMR 20 moves to the predetermined reference area 40 as shown in FIG. 2, the first position can be a position of the object relative to the AMR 20.

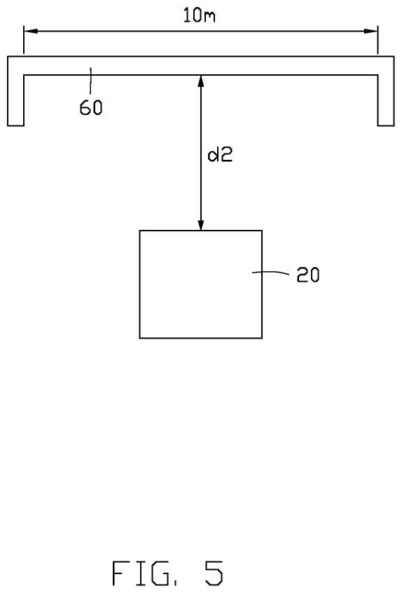

For example, as shown in FIG. 5, the object 60 can be a wall with a length of 10 meters. The predetermined reference area 40 can be an area facing the wall.

In block 402, a second position of the object detected by a LiDAR of the AMR is obtained when the AMR reaches the predetermined reference area.

The LiDAR 21 is installed on the AMR 20, and the LiDAR 21 can move by following a movement of the AMR 20.

In one embodiment, when the LiDAR 21 of the AMR 20 reaches the predetermined reference area 40, the second position of the object detected by thee LiDAR 21 can be a position of the object detected by the LiDAR 21 relative to the predetermined reference area 40.

In one embodiment, referring to FIG. 2, the electronic device 10 communicates with the pressure sensor 31, the pressure sensor 31 is located in the predetermined reference area 40. The electronic device 10 determining the LiDAR 21 reaching the predetermined reference area 40 includes: determining the LiDAR 21 reaching the predetermined reference area 40 when a pressure value is detected by the pressure sensor and the pressure value is within a predetermined pressure range.

In one embodiment, when the electronic device 10 determines the LiDAR 21 reaching the predetermined reference area 40, the electronic device 10 may control the AMR 20 to stop moving.

In one embodiment, referring to FIG. 3, when the electronic device 10 determines the LiDAR 21 reaching the predetermined reference area 40, the electronic device 10 may control the fixed device 50 to fix the AMR 20 in the predetermined reference area 40.

For example, the electronic device 10 communicates with the fixed device 50, the fixed device 50 is arranged in the predetermined reference area 40. Before the block 402, the example method may further includes: sending a first instruction to the fixed device 50 to fix the LiDAR 21 when the LiDAR 21 reaches the predetermined reference area 40. The fixed device 50 can respond the first instruction to fix the LiDAR 21 in the predetermined reference area 40.

For example, the fixed device 50 may include a latch, the AMR 20 may equip a positioning hole that matches with the latch. When the LiDAR 21 reaches the predetermined reference area 40, the electronic device 10 can control the latch to rise and the latch can be inserted into the positioning hole, so that the LiDAR 21 can be fixed at the predetermined reference area 40.

In one embodiment, after the block 402, the example method may further includes: sending a second instruction to the fixed device 50 to release the LiDAR 21. The fixed device 50 can respond the second instruction to release the AMR 20, and the LiDAR 21 is released. For example, the latch of the fixed device 50 declines, and the latch can be pulled out from the positioning hole of the AMR 20.

After the AMR 20 is released, the next AMR of the production line can move to the predetermined reference area 40 to calculate an compensation angle of an LiDAR of the next AMR, so that a batch calculation of the compensation angle can be realized, and the AMRs of the production line can be corrected in batches.

In block 403, a first distance between the second position and the first position is obtained.

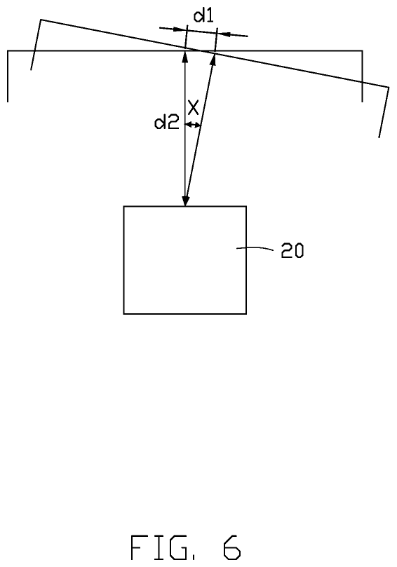

Referring to FIGS. 5 and 6, an objective point can be selected on the object 60, a coordinate of the objective point is defined as the first position. The LiDAR 21 detects the object 60, a detection coordinate of the objective point is obtained by the LiDAR 21, and the detection coordinate of the objective point is defined as the second position, a distance between the first position and the second position is defined as the first distance d1.

In one embodiment, when the first distance d1 is less than a predetermined distance, the LiDAR 21 is determined to meet a predetermined installation standard, and the compensation angle of the LiDAR 21 can be determined according to the first distance.

In one embodiment, when the first distance d1 is greater than the predetermined distance, the LiDAR 21 is determined to not meet the predetermined installation standard, and a prompt of reinstalling the LiDAR 21 is outputted.

In one embodiment, the predetermined distance can be defined according to an actual application requirement. For example, the predetermined distance can be defined according to a second distance between the predetermined reference area 40 and the object 60 and an assembly accuracy of the LiDAR 21.

For example, the second distance between the predetermined reference area 40 and the object 60 is 5m, the predetermined distance can be 0.05 cm.

The assembly accuracy of the LiDAR 21 can be determined to meet the predetermined installation standard or not through the first distance. If the LiDAR 21 is determined to not meet the predetermined installation standard, the LiDAR 21 can be reinstalled, so as to improve a yield of LiDAR 21. If the LiDAR 21 is determined to meet the predetermined installation standard, a calculation of the compensation angle is performed, and the detection accuracy of the LiDAR 21 is improved.

In block 404, the compensation angle of the LiDAR is determined according to the first distance.

In one embodiment, the compensation angle is configured to compensate an angle detected by the LiDAR 21. The compensation angle can be able to describe a deviation angle and a deviation direction of the second position relative to the first position.

In one embodiment, the electronic device 10 determining the compensation angle of the LiDAR 21 according to the first distance comprises: obtaining the second distance between the predetermined reference area 40 and the object 60; obtaining a sinusoidal value of the compensation angle according to a ratio of the first distance and the second distance; and determining the compensation angle of the LiDAR 21 according to the sinusoidal value.

For example, referring to FIG. 6, the electronic device 10 can obtain the second distance d2 between the predetermined reference area 40 and the object 60, calculate the ratio of the first distance d1 and the second distance d2, and further calculate the sinusoidal value sin x of the deviation angle x according to the ratio of the first distance and the second distance. The deviation angle x can be determined by the sinusoidal value sin x.

In one embodiment,

$$sin x = ( \frac{1}{2} {d}_{1} ) / {d}_{2} , x = {sin}^{- 1} ( \frac{{d}_{1}}{2 {d}_{2}} ) .$$

The embodiments can calculate the compensation angle through a trigonometric function, and the compensation angle of the LiDAR 21 can be accurately obtained under a limited correction field.

In one embodiment, when the electronic device 10 obtains the compensation angle, the compensation angle can be transmitted to the AMR 20. After the LiDAR 21 of the AMR 20 obtains an initial detection angle of the object, the actual angle of the object can be obtained according to the compensation angle and the initial detection angle.

For example, the compensation angle as shown in FIG. 6 deviates by 0.1 degree clockwise, and the initial detection angle of the object detected by the LiDAR 21 is 20 degrees, 20 degrees are rotated counterclockwise by 0.1 degrees to obtain 19.9 degrees, and 19.9 degrees is the actual angle of the object.

For example, the compensation angle as shown in FIG. 6 deviates by 0.1 degree counterclockwise, and the initial detection angle of the object detected by the LiDAR 21 is 20 degrees, 20 degrees are rotated clockwise by 0.1 degrees to obtain 20.1 degrees, and 20.1 degrees is the actual angle of the object.

The angle compensation system 100 of the embodiments can control the AMR 20 automatically move to the predetermined reference area 40 for calibration detection, comparing with manual observation whether the AMR 20 moves to the predetermined reference area 40 or not, an calibration accuracy can be improved, and when the AMR 20 moves to the predetermined reference area 40, the compensation angle of the LiDAR 21 of the AMR 20 is automatically calculated, so that an efficiency of angle compensation is improved, and a test efficiency of the production line is improved.

Referring to FIG. 1, the AMR 20 includes the LiDAR 21. The AMR 20 is configured to obtain the initial detection angle of the object detected by the LiDAR 21, obtain the actual angle of the object according to the compensation angle and the initial detection angle. The compensation angle is obtained by using the angle compensation method as shown in FIG. 4.

In one embodiment, the AMR 20 obtaining the actual angle of the object according to the compensation angle and the initial detection angle comprises: rotating the initial detection angle counterclockwise to N degrees to obtain the actual angle of the object when the compensation angle is N degrees of clockwise deflection of the second position relative to the first position; or rotating the initial detection angle clockwise to N degrees to obtain the actual angle of the object when the compensation angle is N degrees of counterclockwise deflection of the second position relative to the first position.

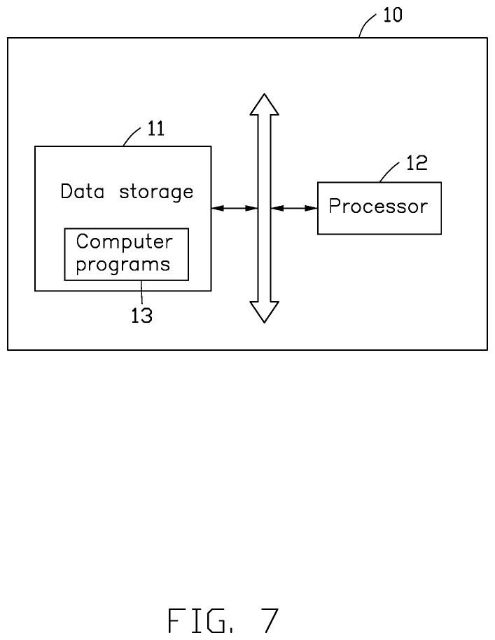

FIG. 7 illustrates one exemplary embodiment of the electronic device 10. The electronic device 10 may include a data storage 11 and a processor 12. The data storage 11 is configured to store one or more computer programs 13. The one or more computer programs 13 are configured to be executed by the processor 12. The one or more computer programs 13 comprise instructions, and the instructions is capable of being executed by the electronic device 10 to implement the angle compensation method.

It can be understood that the structure shown in FIG. 7 does not constitute a limitation on the electronic device 10. In other embodiments, the electronic device 10 may comprise more or fewer components than shown in FIG. 7, or combine some components, or separate some components, or arrange different components.

The processor 12 may comprise one or more processing units, for example, the processor 12 may comprise an application processor (AP), a modem, a graphics processing unit (GPU), an image signal processor (ISP), a controller, a video codec, a digital signal processor (DSP), a baseband processor, and/or a neural network processing unit (NPU), etc. Different processing units may be independent components, or may be integrated in one or more processors.

A memory may also be integrated in the processor 12 for storing instructions and data. In some embodiments, the memory integrated in processor 12 is a cache memory. The memory may store instructions or data that the processor 12 has just used or recycled. If the processor 12 needs to use the instruction or data again, it can be directly recalled from the memory, and a repeated store and read is avoided. A waiting time of the processor 12 is reduced, and an efficiency of the system is improved.

In one embodiment, the processor 12 may comprise one or more interfaces. The interfaces may comprise an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, and/or a universal serial bus (USB) interface, etc.

In one embodiment, the data storage 11 may comprise a high-speed random access memory, and may also comprise a non-volatile memory, such as a hard disk, an internal memory, a plug-in hard disk, a smart media card (SMC), a secure digital (SD) card, a flash card, at least one magnetic disk memory, a flash memory, or other non-volatile solid-state memory.

In one embodiment, a non-transitory storage medium recording instructions is also provided. When the recorded computer instructions are executed by a processor of the electronic device 10, the electronic device 10 can perform the device interaction method.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An angle compensation method applied to an electronic device, comprising:
obtaining a first position of an object, wherein the first position is an actual position of the object relative to a predetermined reference area;
obtaining a second position of the object detected by a light detection and ranging (LiDAR) when the LiDAR reaches the predetermined reference area;
obtaining a first distance between the second position and the first position; and
determining a compensation angle of the LiDAR according to the first distance, wherein the compensation angle is configured to compensate an angle detected by the LiDAR.

2. The angle compensation method of claim 1, wherein after obtaining the first distance between the second position and the first position, the method further comprises:
determining the LiDAR meets a predetermined installation standard when the first distance is less than a predetermined distance.

3. The angle compensation method of claim 2, wherein determining the compensation angle of the LiDAR according to the first distance further comprises:
determining the compensation angle of the LiDAR according to the first distance when the LiDAR meets the predetermined installation standard.

4. The angle compensation method of claim 2, wherein after obtaining the first distance between the second position and the first position, the method further comprises:
determining the LiDAR does not meet the predetermined installation standard when the first distance is greater than the predetermined distance; and
outputting a prompt of reinstalling the LiDAR.

5. The angle compensation method of claim 1, wherein determining the compensation angle of the LiDAR according to the first distance further comprises:
obtaining a second distance between the predetermined reference area and the object;
obtaining a sinusoidal value of the compensation angle according to a ratio of the first distance and the second distance; and
determining the compensation angle of the LiDAR according to the sinusoidal value.

6. The angle compensation method of claim 1, wherein the electronic device communicates with a fixed device, the fixed device is located in the predetermined reference area, and before obtaining the second position of the object detected by the LiDAR, the method further comprises:
sending a first instruction to the fixed device to fix the LiDAR when the LiDAR reaches the predetermined reference area, and
after obtaining the second position of the object detected by the LiDAR, the method further comprises:
sending a second instruction to the fixed device to release the LiDAR.

7. The angle compensation method of claim 1, wherein the electronic device communicates with a pressure sensor, the pressure sensor is located in the predetermined reference area, and before obtaining the second position of the object detected by the LiDAR when the LiDAR reaches the predetermined reference area, the method further comprises:
determining the LiDAR reaches the predetermined reference area when a pressure value is detected by the pressure sensor and the pressure value is within a predetermined pressure range.

8. An autonomous mobile robot (AMR) comprising a light detection and ranging (LiDAR), the AMR configured for obtaining an initial detection angle of an object detected by the LiDAR, and obtaining an actual angle of the object according to a compensation angle and the initial detection angle, wherein the compensation angle is obtained by using an angle compensation method, the angle compensation method comprising:
obtaining a first position of the object, wherein the first position is an actual position of the object relative to a predetermined reference area;
obtaining a second position of the object detected by the LiDAR when the LiDAR reaches the predetermined reference area;
obtaining a first distance between the second position and the first position; and
determining the compensation angle of the LiDAR according to the first distance.

9. The AMR of claim 8, wherein the AMR is configured to rotate the initial detection angle counterclockwise to N degrees to obtain the actual angle of the object when the compensation angle is N degrees of clockwise deflection of the second position relative to the first position, and
the AMR is further configured to rotate the initial detection angle clockwise to N degrees to obtain the actual angle of the object when the compensation angle is N degrees of counterclockwise deflection of the second position relative to the first position.

10. An electronic device comprising:
at least one processor; and
a data storage storing one or more programs which when executed by the at least one processor, cause the at least one processor to:
obtain a first position of an object, wherein the first position is an actual position of the object relative to a predetermined reference area,
obtain a second position of the object detected by a light detection and ranging (LiDAR) when the LiDAR reaches the predetermined reference area,
obtain a first distance between the second position and the first position, and
determine a compensation angle of the LiDAR according to the first distance, wherein the compensation angle is configured to compensate an angle detected by the LiDAR.

11. The electronic device of claim 10, wherein the at least one processor is further caused to:
determine the LiDAR meets a predetermined installation standard when the first distance is less than a predetermined distance.

12. The electronic device of claim 11, wherein when the at least one processor determines the compensation angle of the LiDAR according to the first distance, the at least one processor is further caused to:
determine the compensation angle of the LiDAR according to the first distance when the LiDAR meets the predetermined installation standard.

13. The electronic device of claim 11, wherein the at least one processor is further caused to:
determine the LiDAR does not meet the predetermined installation standard when the first distance is greater than the predetermined distance, and
output a prompt of reinstalling the LiDAR.

14. The electronic device of claim 10, wherein when the at least one processor determines the compensation angle of the LiDAR according to the first distance, the at least one processor is further caused to:
obtain a second distance between the predetermined reference area and the object,
obtain a sinusoidal value of the compensation angle according to a ratio of the first distance and the second distance, and
determine the compensation angle of the LiDAR according to the sinusoidal value.

15. The electronic device of claim 10, wherein the electronic device communicates with a fixed device, the fixed device is located in the predetermined reference area, the at least one processor is further caused to:
send a first instruction to the fixed device to fix the LiDAR when the LiDAR reaches the predetermined reference area.

16. The electronic device of claim 15, wherein the at least one processor is further caused to:
send a second instruction to the fixed device to release the LiDAR.

17. The electronic device of claim 10, wherein the electronic device communicates with a pressure sensor, the pressure sensor is located in the predetermined reference area, the at least one processor is further caused to:
determine the LiDAR reaches the predetermined reference area when a pressure value is detected by the pressure sensor and the pressure value is within a predetermined pressure range.
